(19) United States
(12) Patent Application Publication
(10) Pub. No.: US 2007/0176424 A1
(43) Pub. Date: Aug. 2, 2007

(54) Preloaded Tubular Connector

(75) Inventor: Philippe C. Nobileau, Villefranche sur Mer (FR)

Correspondence Address: PHILIPPE NOBILEAU, 2 AVENUE FERNAND MARTIN, VILLEFRANCHE SUR MER, 06230, FR

(73) Assignee: Philippe C. Nobileau, Villefranche sur Mer (US)

(21) Appl. No.: 10/908,057

(22) Filed: Apr. 26, 2005

(30) Foreign Application Priority Data
Dec. 23, 2004 (FR) 0413880

(51) Int. Cl. F16L 13/14

(52) U.S. Cl. 285/382

(57) ABSTRACT

A preloaded connector to connect sealingly two pipe segments having a common axis, comprising at least one couple of cooperating pin and box members, the members including load-bearing surfaces to transmit tension and compression axial forces, the connector comprising means to apply, after engagement of the members, a sufficient axial force on at least one of the members, to modify in the plastic range the axial length of at least a portion of said members, so that after release of the axial force a preload subsists on the load-bearing surfaces.

### TECHNICAL FIELD

This invention concerns sealed connections of pipe segments notably for use in oil and gas wells.

### BACKGROUND

In oil and gas wells, for drilling or production, casing string comprising length of pipe, made-up on the drilling floor during running, are usually lowered into the well. Due to the very harsh conditions met downhole, connector sealing is usually of the metal-to-metal type. It is, moreover, necessary to avoid clearance in the connector by preloading it in order to prevent possible parting while lowering into the well and also to increase fatigue performance during production.

Connectors to connect the segments are generally of the threaded type of at least one couple of cooperating pin and box members which requires during their make-up, the rotation of one of the segments with regards to the others. This type of threaded connector exhibits few major problems. First, when the pipe segments to handle are of large diameter, rotation is difficult. Then, with present connectors, the need to make a metal-to-metal seal and deliver a tight connector require relative rotation of the loaded load-bearing surfaces and sealing surfaces of both pipe segments. Because of the galling problems that can result, the use of certain materials for the pipe segments and connector members is difficult and sometimes impossible. Moreover, with this type of connector, a good sealing quality does not tolerate small defects such as a local damaging of thread or shoulder which can occur during pipe segment handling. Another disadvantage of threaded connectors comes from the fact that connecting member machining is comparatively long and costly because the helical threads are obtained by machine threading which is a much slower operation than simple machine turning.

To avoid such drawbacks, snap-on pin and box connectors, without relative rotation, have been proposed to be made-up hydraulically by expanding the box member and shrinking the pin member. This technology which requires very precise machining substantially increases cost and creates additional make-up constraint on the drilling floor.

More particularly, in the case of connecting pipe segments for casing a well, there is a technology which requires the connection of pipe segments which are axially folded in order to permit their lowering through a previously run casing made-up of pipe segments of the same diameter, already unfolded inside the well. This allows to case the whole well with only one casing diameter saving important volume of drilled formation, casing and cement slurry, which allows the reduction of drilling cost and time. For such application, the use of threaded connectors creates additional problems coming from the impossibility of relative rotation of the cooperating members if they are already folded. To solve the problem related to the connection of folded pipe segments, the U.S. Pat. No. 5,794,702 of the inventor describes a continuous folded casing, coiled on a spool, so that there is no connection to be made-up during the string running into the well. But today, only the very small diameter pipes (around 2-3″ of outside diameter) are lowered into wells by using the coiled technology whereby the pipe is unreeled and straightened by plastic deformation while being lowered. The use of this method of continuous spooled casing, for a casing diameter of which will be between 5″ and 10″, requests major modifications of drilling rigs. In consequence, it is highly desirable to have a high performance connector with fast make-up dedicated to the sealed connection of straight segments of folded pipe, while lowering the casing into the well.

### SUMMARY

The object of the present invention is to provide a new type of sealed pipe connector by making-up at least one couple of cooperating pin and box members, avoiding the disadvantages previously described, either for the connection of tubular pipe segments or folded pipe segments, particularly:
for the connection of two tubular pipe segments, to obtain a sealed and preloaded connector without relative thread rotation when they are preloaded,
for the connection of two tubular pipe segments, to obtain a sealed and preloaded connector as described above in which the engagement of cooperating pin and box is achieved without relative rotation and without requiring an internal hydraulic assistance,
for the connection of axially folded pipe segments, to obtain an axially folded, sealed and preloaded connector maintaining its preload and its sealing integrity during all the phase of deployment and possible enlargement.

According to one of the essential characteristics of the invention, the cooperating load-bearing surfaces of the cooperating pin and box members, transmitting the string's axial tension and compression, are preloaded by shortening, in the plastic range, the length of the box member. This crushing allows in a simple and quick manner to eliminate all the clearances in the connector without the need of high precision geometry of the members and even in the case these members are slightly damaged. On the other hand, the preloading of load-bearing surfaces serves favorably in maintaining the metal-to-metal quality sealing during installation and reduce fatigue during service loads.

The result of this feature is the preloading of the sealing surfaces without substantial sliding. This prevents possible galling problems allowing the use of a broader range of materials, notably those more susceptible to resistance to certain type of corrosion.

According to another feature of the invention, the engagement of the load-bearing surfaces prior to preloading can be performed by threading. In this case, the load-bearing surfaces carrying the string weight and handling the tension are of helicoidal shape.

According to another feature of the invention, the engagement of the load-bearing surfaces prior to preloading can be done by elastic separation between cooperating members. Separation is done by expanding the box member and squeezing the pin member by the sliding of the inclined or tapered stabbing flanks of the threads or grooves located on the outside of the pin member and on the inside of the box member.

The configuration according to the present invention has the advantage to permit connection to be made with a folded connector of axially folded pipe segments. The advantage is that the make-up on the drilling floor is no more complex, nor more time consuming than a classical connection of tubular pipe segments. Another advantage of this connector is that the preloading and sealing qualities are maintained during the entire unfolding of pipes and connectors in the well which will be done by either applying internal pressure to the string and/or by mechanical expansion.

According to another feature of the invention, the opposed tension and compression load-bearing surfaces can form a dovetail-shaped engagement in order that once preloaded, it resists radial separation of the connecting member walls. This feature is particularly useful during the unfolding of folded connectors.

In the case of axially folded connectors, the invention locates the folding of the connection members predominantly on thinner axial zones. In that way, large load carrying zones remain non-deformed and fully cooperate before, during and after unfolding.

Other features and advantages of the invention will be appreciated by the consideration of the figures and the description below, illustrating and describing preferred embodiments of connectors and methods to make them up with the present invention and provided as examples in no way limitative.

### BRIEF DESCRIPTION OF THE DRAWINGS

FIG. 1A is a schematic axial section view of a connector according to the invention prior to preloading.

FIG. 1B is a schematic axial section view of a connector according to the invention after preloading.

FIG. 1Bbis is an enlarged view of FIG. 1B showing more particularly the actuation of the preloading.

FIGS. 2A, 2B and 2C are section and perspective views of a connector according to the invention, of the coupling type with helicoidal tension load-bearing surfaces, before engagement of the load-bearing surfaces in the respective states: before screwing, after screwing and preloaded.

FIGS. 2Bbis and 2Cbis are enlarged views of the respective FIGS. 2B and 2C.

FIGS. 3A, 3B and 3C are section and perspective views of a connector according to the invention, of the coupling type with rotationless axial stabbing in the respective states: before engaging the cooperating load-bearing surfaces, after engaging the cooperating load-bearing surfaces and preloaded.

FIGS. 3Abis, 3Bbis and 3Cbis are enlarged views of the respective FIGS. 3A, 3B and 3C.

FIGS. 4A, 4B; 4C and 4D are section and perspective views of a connector according to the invention, of the folded pipe segments with axial stabbing type, in the respective states: radially separated load-bearing surfaces, separated but engaged load-bearing surfaces, preloaded load-bearing surfaces.

FIG. 5 is a section and perspective view illustrating the successive component stack up order of a connector according to the invention of the coupling type to connect two axially folded pipe segments.

FIG. 6 is a radial section view showing the running of a pipe segment and its connector axially folded inside a segment of an already unfolded pipe.

FIG. 7 is a section and perspective view of a folded pipe including a connector according to the invention of the coupling type going down through a casing previously installed and unfolded of the same dimension.

FIG. 8A in 8D are section views of a connector's wall according to the invention such as represented on FIGS. 5 to 7 illustrating the running sequence.

FIG. 9 is a perspective view of the connector make-up tool as shown on FIG. 5, the vertical cylinder bodies having been removed for clarity.

FIG. 10 is a top view of the make-up tool which left and right half views shows respectively before and after radial engagement of the coupling.

FIG. 11 is a radial section view of the handling tool for the folded pipe segment.

FIG. 12 is a perspective view of the handling tool for folded pipe segment illustrating its installation on the pipe segment when it is horizontal

FIG. 13 is a perspective view of the handling tool and the make-up tool as configured on the drilling floor during running in of the string.

FIGS. 14 and 15 are section and perspective views of a connector according to the invention of the axial stabbing type with only a single couple of pin and box members to connect two folded pipe segments.

### DETAILED DESCRIPTION

To facilitate the understanding of the present description, we will use the term axial to designate what is parallel to the longitudinal direction of the pipe segments to be connected. At the opposite we will use the term radial to indicate what is in the perpendicular plan to this direction. Considering that the casing string, made of connected pipe segments, is lowered vertically into the well, we will use the terms up, low, downwards, upwards, upper or lower.

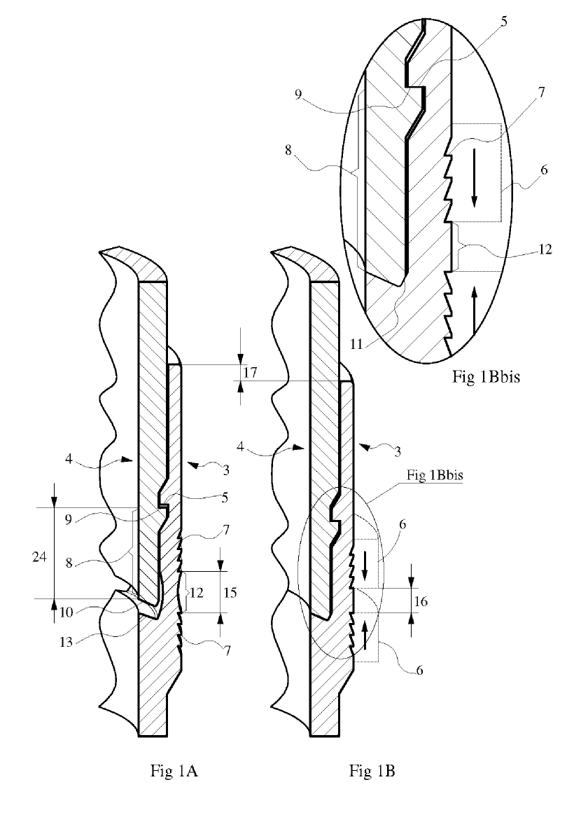

In reference to FIGS. 1A, 1B and 1Bbis the connector principle according to the invention consists of the engagement of at least one couple of pin member 4 and box member 3. One of the essential features of the invention is the way the load-bearing surfaces, handling the tensile and compression load from the string, are pre-loaded. The tension load-bearing surfaces 5 and 9 and the compression load-bearing surfaces 10 and 13 are first engaged with clearance and without large load except the weight of the segment (FIG. 1A). To apply the preload to the load-bearing surfaces 5, 9, 10 and 13, the jaws 6, engaged in the grooves 7 on the external surface of the box member 3, apply compression to the circumferential portion 12 so that it shortens plastically from length 15 to length 16 (FIGS. 1B and 1Bbis). In the case that both members are made of materials of identical mechanical performances, it is necessary that the length 24 is longer than the length 16. In this way, for a similar displacement between the jaws 6, the portion of the pin member put in compression through the load-bearing surfaces 5, 9, 10 and 13 is subjected to a lesser percentage of elongation than the portion 12 of the box member located between the jaws, as a result of what, after release of the forces on the jaws, the portion 12 will have been more plastically shortened in percentage than the portion 8 of the pin member. If the plastic reduction of length 17 of the box member is greater to the sum of initial gaps between the opposite load-bearing surfaces, the connector will retain some preload with a compression in the pin member 4 balanced by a tension in the box member 3. The same result can be achieved by using different elastic performances of material instead of different lengths of the portion 12 and 8. The sealing surface 10 comprises a conical face 11 where strong contact pressure, by loading in hoop stress the connecting members, is applied to achieve a reliable metal-to-metal seal.

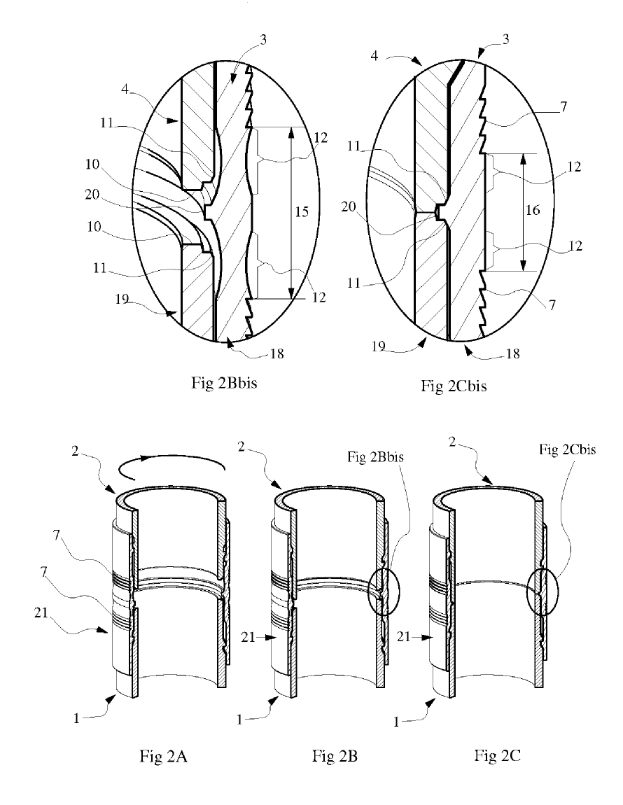

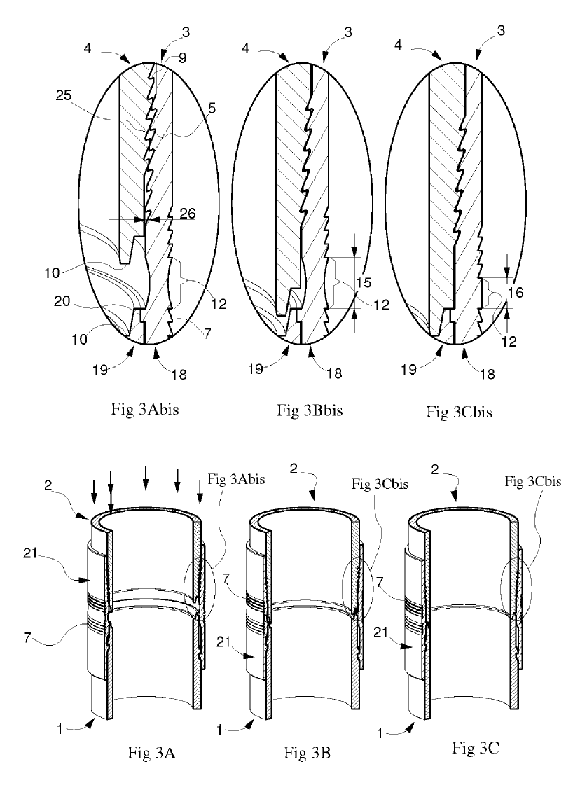

Referring to FIGS. 2A, 2B and 2C, the invention applies to a connector of the coupling type. The coupling 21 includes two box members 3 and 18 cooperating respectively with the pin members 4 and 19 of both pipe segments 1 and 2 to be connected. Prior to preloading (FIG. 2A), the box member 18 is loosely screwed on the pin member 19 by engaging the helicoidal threads. The pin member 4 of the segment 2 is then engaged in the same way in box member 3 of the coupling 21, until all load-bearing surfaces are face to face with clearance (FIGS. 2B and 2Bbis). The central portion of the coupling 21 (FIGS. 2C and 2Cbis) is then shortened. This portion consists of two thinner zones 12 which will concentrate most of the plastic deformation and a thicker zone supporting a centralizing seal surface 20 coming in contact with the compression shoulders 10 of the pin members to equalize the plastic deformation of both portions 12. The compression shoulder of the pin member includes a conical face 11 where strong contact pressure, by loading in hoop stress the connecting members, is applied to achieve a reliable metal-to-metal seal.

Referring to FIGS. 3A, 3B and 3C, the invention discloses the use of a connector of the coupling type of which one of the couples of connecting members is stabbed axially by elastic radial deformation. This couple of pin member 4 and box member 3 includes several tension load-bearing surfaces 5 and 9 of small engagement separated by stabbing flanks 25. The coupling 21 is first screwed loosely on the pin member 19 of the pipe segment 1 until bottomed by the centralizing ring 20. The pin member 4 is then stabbed axially on the box member 3 of the coupling 21 so that the stabbing flanks 25 come in contact (FIGS. 3A and 3Abis). When a strong axial compression is then momentarily applied on the couple of members 3 and 4, the stabbing flanks in contact 25 slide against one another creating a radial separation of the walls of pin and box members by wedging until the load-bearing surfaces snap back partially in axial engagement. This operation can be repeated several times before full engagement of load-bearing surfaces is achieved, according to the depth of the load-bearing surfaces and their radial offset (FIGS. 3B and 3Bbis). In certain cases, to maximize the radial final engagement of the tension load-bearing surfaces 5, the maximum separation 26 of the walls before snapping must be such that they do not exceed material yield in hoop compression for the pin 4 and in hoop tension for the box 3. The upper box member of the coupling 21 is then shortened in the plastic range at the level of the thinner portion 12 to achieve adequate preloading of all the load-bearing surfaces, including the load-bearing surfaces of the couple of lower connecting members 18 and 19 (FIGS. 3C and 3Cbis).

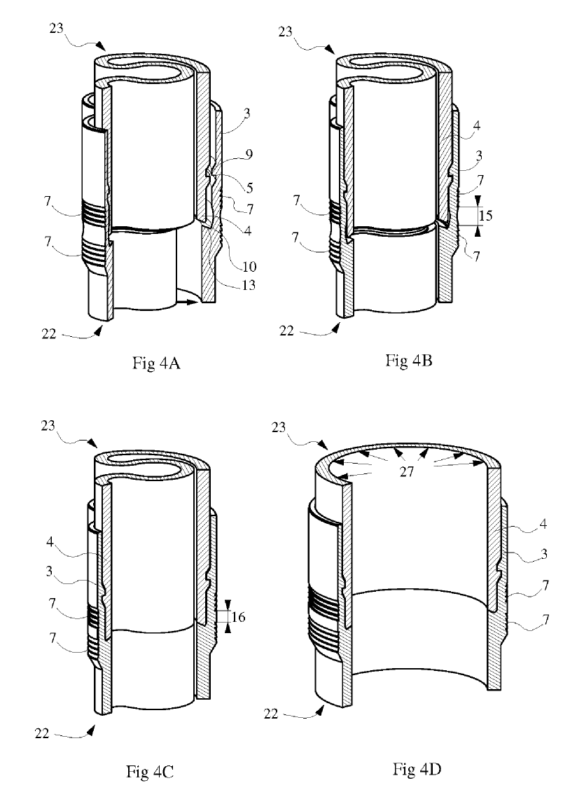

Referring to FIG. 4A in 4D, the invention discloses the use of a connector of the “no coupling” type, with simple mating of pin and box members to connect axially folded pipe segments 22 and 23. The connecting members 3 and 4 being folded axially, the stabbing is mandatorily made without rotation. To be able to stab together the connecting members without interference between the tension load-bearing surfaces 5 and 9, the box member 3 is less folded than the pin member 4 leaving clearance between the connector walls when the connecting members are stabbed with the compression shoulders 10 and 13 (FIG. 4A) in contact. The box member 3 is then intimately wrapped onto the pin member 4 in order to radially engage the load-bearing surfaces face to face in the axial direction (FIG. 4B). The length of the box member 3 is then shortened plastically by jaws engaging the grooves 7 (FIG. 4C). The preloaded inverted slope of the compression shoulders 10 and 13 provides sealing and prevents the radial separation of the connecting member's walls during all the phases of unfolding to come. The pipe segments 22 and 23 as well as the connector are then plastically unfolded either by application of an internal pressure 27 (FIG. 4D) or by forcing a mechanical opening tool. The connection can then be expanded slightly, to enhance its roundness and in consequence its resistance to external pressure, by displacement of an expansion mandrel having circular sections.

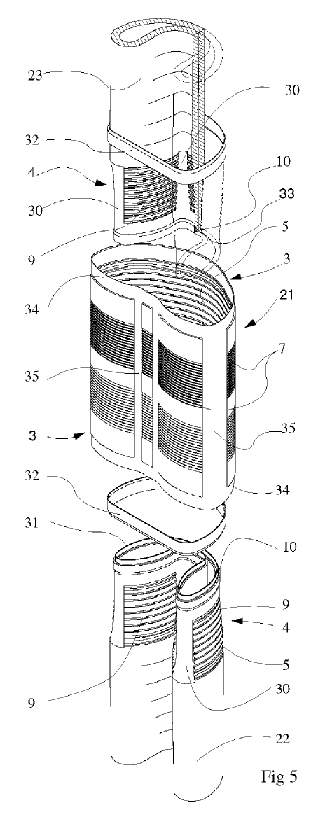

FIG. 5 illustrates the stack-up order of the components providing an advantageous embodiment of the invention with a coupling to connect two segments of axially folded pipe 22 and 23. The pin members 4 of the pipe segments include zones of tension load-bearing surfaces 9 separated by longitudinal zones of reduced thickness 30 which act as axial hinges for folding/unfolding connecting members. The compression load-bearing surface 10 of pin member 4 includes a sealing gasket groove 33 to receive a seal gasket also folded with a diamond-shaped section 31. The coupling 21, illustrated in its pre-folded shape before make-up, includes on its internal surface cooperating load-bearing surfaces 5 to the load-bearing surfaces 9 and includes on its external surface grooving 7 for receiving the jaws separated by longitudinal zones 35 of reduced thickness which act as axial hinges for folding/unfolding of the members. Coupling 21 includes on the end of its two box members, a recess 34 to receive the locking band 32 after make-up. Machining of the profiles of member 3 and 4 on the ends of the pipe segment will preferably be made by machine turning before folding the segment for economic reasons. During folding, load-bearing surfaces 5 cooperating load-bearing surfaces 9 will be undeformed, due to the longitudinal zones 35 of reduced thickness. After folding, there could be a heat treatment to relax folding stresses and regain maximum material elongation performance for the downhole unfolding step.

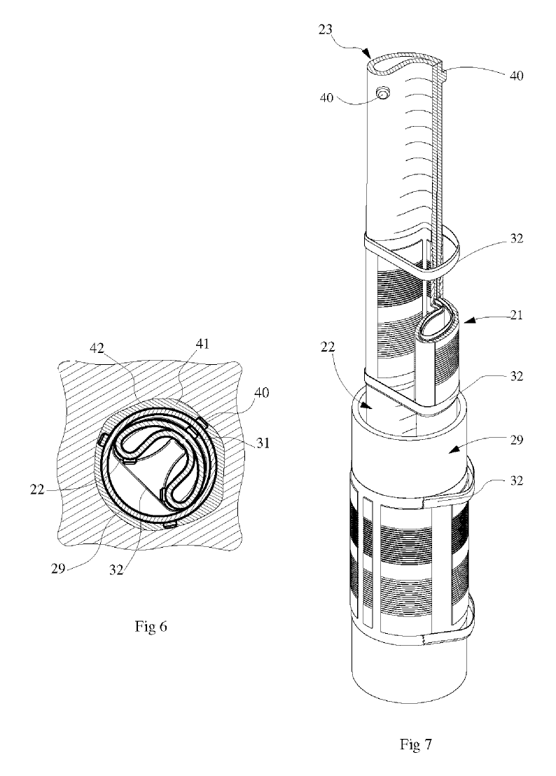

Reference to FIGS. 6 and 7 which illustrates the installation in the well of a string of axially folded pipe, the casing string 28 made up of segments of pipe axially folded 22 and 23 can be lowered through a previously set casing string 29 of the same dimension which has been already unfolded and expanded into the well. Once having lowered the string 28 underneath the string 29, the string 28 can be unfolded and expanded, segments 22 and 23 and the connector 21 take their final cylindrical shape by breaking the locking bands 32. On the other hand, the internal circumference of box members of coupling 21 is slightly less than the external circumference of pin members, so that after unfolding and expansion of the assembly an interference fit is achieved between the cooperating members delivering a solid connection. Centralizing pins 40 allow to maintain the cylindrical casing off the wellbore 42, so that cement 41 can be circulated freely around the casing to obtain a good cement job with the drilled formations.

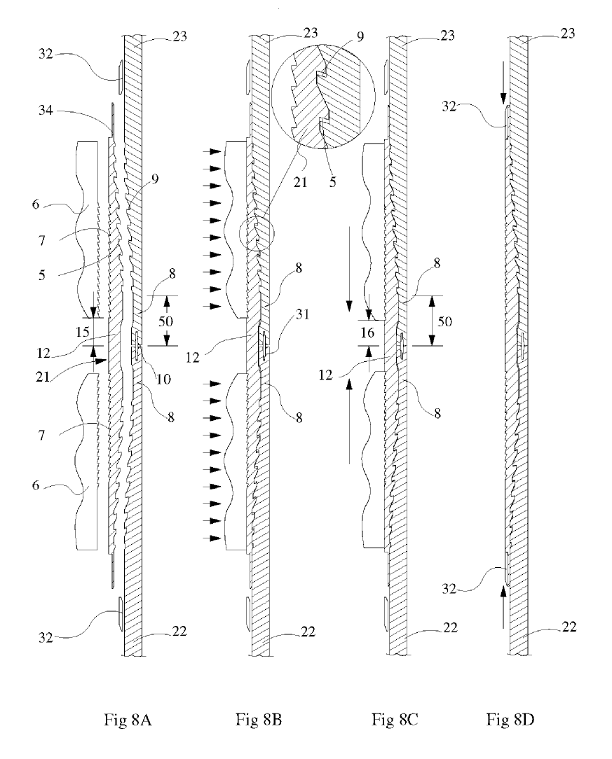

FIGS. 8A to 8D illustrate, with axial sections, the sequence of connecting two segments of pipe 22 and 23 using the connector of the coupling type, such as represented in FIG. 5, made of materials with identical specification. The first step of the connection is the radial engagement of the coupling 21 by displacement of the compression jaws 6 engaged in the groovings 7 of the coupling (FIG. 8A) so that the cooperating load-bearing surfaces 5 and 9 of the connecting members are facing one another loosely in the axial direction (FIG. 8B). Then, the jaws 6 allow momentarily to apply, via the groovings 7, a strong axial compression force at the level of the peripheral portion 12 which reduces the length 5 to a length 16, in the plastic range, creating a pre-load between the load-bearing surfaces 9 and 5, the compression shoulder 10 and the conical seal 31 (FIG. 8C). As described in FIGS. 1A and 1B, the pre-loading is made possible by the fact that the length 50 of portion 8 is greater than the length 15 of portion 12. The cooperating load-bearing surfaces 5 and 9 have inverted slopes (FIG. 8B bis) so that once pre-loaded, they resist radial separation of the member's walls. The walls of cooperating members are therefore forced to stay in contact during unfolding and expansion of the connector despite a limited relative peripheral sliding of the cooperating load-bearing surfaces. Moreover, the pre-loading on the compression shoulder 10 and the tapered section seal gasket 31 allows to maintain a quality sealing of connector's members during all the running, the reinflation and the expansion phases downhole. Finally, the locking bands 32 are engaged in their respective recesses 34 to contain the radial elastic springback and to prevent any unsnapping of the folded connector during the whole string running.

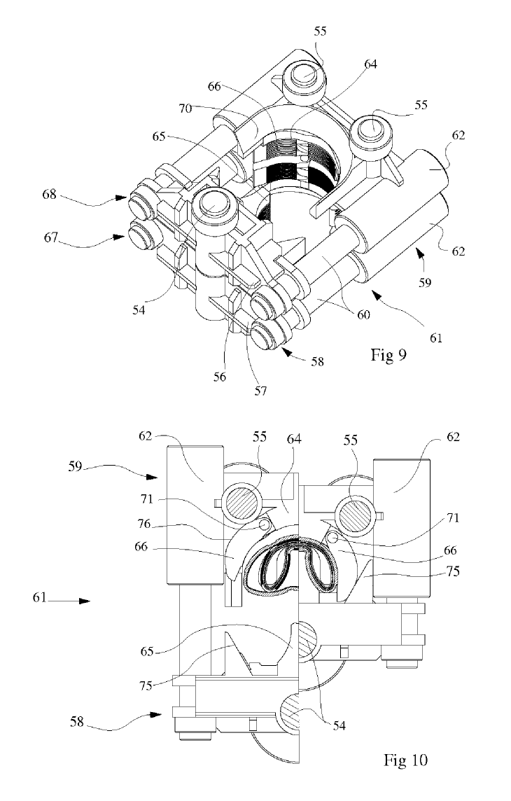

In reference to FIG. 9, the make-up tool 61 used for connecting the pipe segments with a connector of coupling type such as represented in FIGS. 5 to 8, comprises an upper sub-assembly 68 and a lower sub-assembly 67 able to move vertically closer by the action of both cylinders 55 and cylinder 54. On the other hand, each of the sub-assemblies 67 and 68 of the make-up tool 61 includes a convex front part 58 and a cup-shaped back part 59 which can move horizontally closer by action of cylinders 62. The relative horizontal translation of parts 58 and 59 of the tool is used for the first step of radial deformation of the coupling 21 in order to engage face to face, in the axial direction, the cooperating load-bearing surfaces. The relative vertical translation of sub-assembly 67 and 68 of the tool, is then used for the step of plastic reduction of the length of the coupling 21. To make-up a connection of 6⅝″ pipe segments, using the connector as represented in FIGS. 5 to 8, the invention anticipates the use of four cylinders 60 of 33,000 lbs (15,000 daN) force for relative horizontal translation and two cylinders 55 and a cylinder 54 of 180,000 lbs (80,000 daN) and 290,000 lbs (130,000 daN) of respective forces. The force transmission between the tool and the coupling 21 is done by jaws 64 and 66 carried by the cup-shaped parts 59 of the tool and by jaws 65 carried by the convex part 58 of the tool. These jaws feature cooperating grooving to grooving 7 of the coupling 21 to allow to transmit axial forces without slippage. The funnel 70 is used during make-up for easy docking of the lower pin member of the added segment into the pre-folded coupling 21.

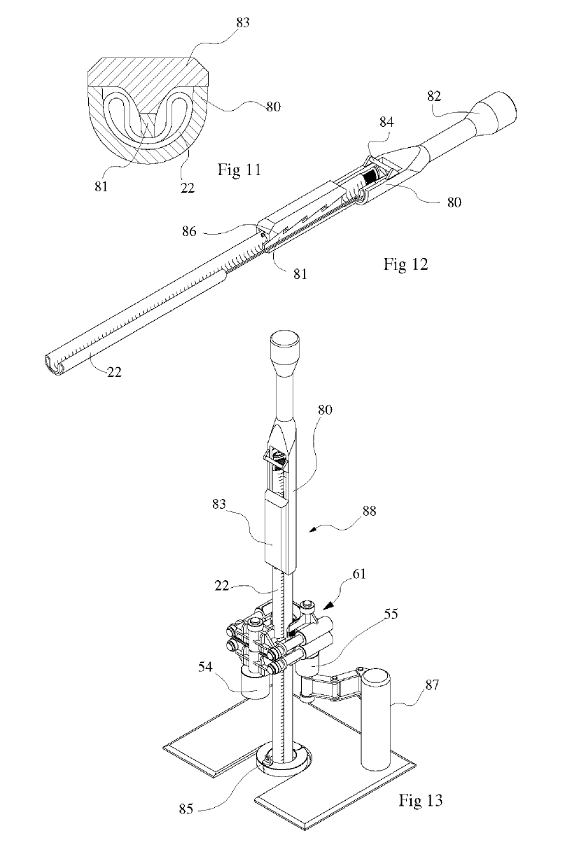

Reference to the FIG. 10, which illustrates a horizontal section of the make-up tool between the sub-assemblies 68 and 67, the radial deformation mechanism of the coupling 21 allows, with a single stroke of cylinders 60, to produce a coupling 21 deformation in both axis of the horizontal plan. To achieve this, jaws 66 are hinged on the axles 71 and their faces 76 slide on the ramps 75 of the convex part 58 of the tool. So, when the first radial folding step ends, all the jaws 64, 65 and 66 are fully engaged on the entire groovings 7 of the coupling 21 in order to permit transmission of the axial compression forces needed for the axial shortening step. Cylinders 60 have enough stroke to move the parts 58 and 59 apart and allow the penetration of the handling tool 88 such as illustrated in FIGS. 12 and 13.

Reference to FIGS. 11 and 12, the handling tool 88 is used for handling the segments and lowering the string into the well. The cup-shaped internal face of part 80 of the handling tool 88 allows transmission by friction of the axial force which is applied on the pipe segment 22 due to its own weight and the complete weight of the string in which the segment will be connected. To maintain an important friction force, the multiple wedge slip 81 is forced onto the bottom of the internal fold of pipe segment 22 by riding the ramps 86 of the top convex part 83 so that the contact pressure of the multiple wedge slip 81 onto the segment 22 augments with the downward axial force applied on the segment 22 by the string weight. This is possible because axial folding of the pipe allows to put in contact two diametrically opposed internal portions of internal surface. The handling tool 88 includes a head 82 to provide an interface with conventional derrick drill pipe handling tools. The handling tool 88 includes a lift ring 84 which allows its easy installation on pipe segments when they are on the pipe rack in horizontal position.

Reference to FIG. 13, when a connection has been made, the handling tool 88 allows to lift the entire casing string weight and lower it to a length equal to one pipe segment length. Prior to connecting a new pipe segment, the spider 85 (of which only the top part is shown) takes by friction the weight of the whole string with the same principle of wedge action than the handling tool 88. The handling tool 88 is then released to pick-up the next pipe segment. The spider 85 and the make-up tool 61 articulated on its stand 87 can be removed if needed to clear the well axis area.

The connector, according to the invention, linking two segments of folded pipe such as illustrated on FIGS. 5 to 8, has members easily manufactured by machine turning to generate the load-bearing surfaces when the pipe segments and the coupling are tubular. Once machine turned, members are milled to create thinner longitudinal axial zones 35 and 30 as illustrated on FIG. 5. The pipe segments and the coupling are then folded at the manufacturing plant. Members are folded with big precision easily reproducible due to the hinges created by the thinner zones 30 and 35. It is then possible, prior to delivery from the manufacturing plant, to perform a heat treatment of the pipe segments and coupling so as to optimize the performances of the material having withstanded a strong plastic deformation during folding. The pipe segment connector of the invention will allow a rapid introduction of the technology of drilling and casing in monodiameter by folding, unfolding and expanding a casing string made of segments prior to the introduction of continuous spooled folded casing and will offer to the drillers a high collapse performance casing from the thicker wall over diameter ratio than the one that could be installed in a monodiameter well with only the expansion technology.

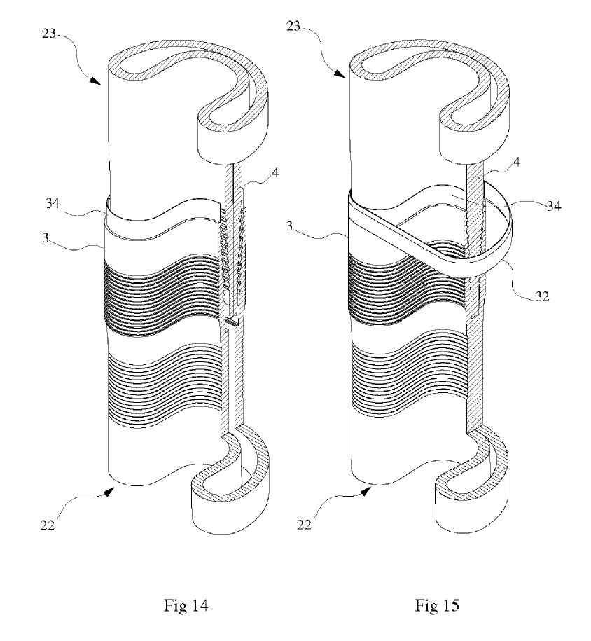

The man skilled in the art will be able to appreciate that the invention is not restricted to the specifics of the previous description, so that a certain number of alternatives could be added within the scope of the invention. For instance, the pipe segments can be joints, length, etc. of casing, tubing, etc. Also, the connector represented in FIGS. 5 to 8 could also have as no “thinner zones” forming hinges, and could be of the type with a single couple of pin and box members or also could be of the type where the making-up face to face of the load-bearing surfaces is carried by radial elastic spacing of members such as illustrated on FIGS. 3A to 3C. FIGS. 14 and 15 represent, as an example, a connector including a single couple of members pin-box 3 and 4 to connect two folded segments of pipe 22 and 23. Prior to making-up the connection, the pin member 4 is more folded than the box member 3 so that they can stab freely. The box member is then wrapped on the pin member to place the cooperating load-bearing surfaces face to face, then crushed axially to pre-load them. To generalize, the preloading of a connector, according to the principle of the invention, is done by axially stretching in the plastic range a portion of at least one of the connector member that will be in compression when the axial stretching force is released and in the absence of other load, or/and by axially shortening in the plastic range a portion of at least one of the connector member that will be in tension when the axial shortening force is released and in the absence of other load. Also, to decrease the plastic deformation force which generates the preload, the portion to be deformed in the plastic range can be heated and, in the case of plastic shortening deformation, at least part of the preload can be obtained from the cooling of such portion.

What is claimed is:

1. A preloaded connector to connect sealingly two pipe segments comprising at least one couple of cooperating pin and box members, said members including load-bearing surfaces to transmit tension and compression axial forces, said connector comprising means to momentarily apply, after engagement of said members, a sufficient axial force on at least one of said members, to modify in the plastic range the axial length of at least a portion of said members, so that after release of said axial force a preload subsists on said load-bearing surfaces.

2. The preloaded connector according to claim 1, wherein said axial length is reduce during the modification in plastic range and wherein the axial length reduction is limited to a circumferential portion of said box member and said circumferential portion has, before said axial length reduction, a progressively thinner wall thickness, so that after said axial length reduction, said circumferential portion does not bulge on the surface of said box member.

3. The preloaded connector according to claim 1, wherein the materials of the surfaces in contact providing sealing are incompatible with rotation under load.

4. The preloaded connector according to claim 1, wherein said pre-loading is sufficient to maintain a seal between said members when the connector is loaded.

5. The preloaded connector according to claim 1, wherein one of said means is provided by at least one groove or shoulder over the peripheral of at least one of said members.

6. The preloaded connector according to claim 1, wherein said load-bearing surfaces transmitting tensile loads are of helicoidal shape adapted for bringing face to face said load-bearing surfaces by relative rotation of the cooperating members.

7. The preloaded connector according to claim 1, wherein engaging said members is at least partially achieved by elastic radial deformation of the pin and the box members.

8. The preloaded connector according to claim 1 wherein the load-bearing surfaces which carry tension are plural and at least two of them are separated by a circular groove.

9. The preloaded connector according to claim 1, wherein at least two cooperating load-bearing surfaces of said members have inverted slope so that said preload generates a force opposing to radial separation of the walls of said members.

10. The preloaded connector according to claim 1, wherein said pin member is axially folded prior said engagement.

11. The connector according to claim 10, wherein the internal circumference of said box member is smaller than the external circumference of said pin member.

12. The preloaded connector according to claim 10, wherein at least one of the axial fold of said pin member is located in one longitudinal zones of reduced thickness.

13. A method to connect sealingly two pipe segments comprising at least one couple of cooperating pin and box members, said members including cooperating load-bearing surfaces to transmit tension and compression axial forces, comprising the steps of:
engaging said cooperating load-bearing surfaces of said members,
preloading said cooperating load-bearing surfaces by momentarily applying an axial constraint in at least one of said members so that the axial length of at least a portion of said member is modified in the plastic range.

14. A method according to claim 13 wherein the first step is achieved by relative rotation of both said members.

15. A method according to claim 13 in witch said pin member has been axially folded, wherein the first step is at least partially achieved by elastic radial deformation of the pin and the box members.

16. A method according to claim 15 wherein there is an additional step of unfolding said members to a substantial tubular shape, after the preloading step.

17. A method according to claim 16 wherein there is an additional step of expansion in the plastic range the diameter of said members, after the unfolding step.

18. A method to connect sealingly two pipe segments with at least one couple of cooperating pin and box members, said members including cooperating load-bearing surfaces to transmit tension and compression axial forces, comprising the steps of:
engaging said cooperating load-bearing surfaces of said members,
preloading said cooperating load-bearing surfaces by momentarily applying an axial tension constraint in at least one of said members so that the axial length of at least a portion of said member is stretched in the plastic range, wherein, in the absence of other load, said portion is in compression after said axial tension constraint is released.

19. A method to connect sealingly two pipe segments with at least one couple of cooperating pin and box members, said members including cooperating load-bearing surfaces to transmit tension and compression axial forces, comprising the steps of:
engaging said cooperating load-bearing surfaces of said members,
preloading said cooperating load-bearing surfaces by momentarily applying an axial compression constraint in at least one of said members so that the axial length of at least a portion of said member is shortened in the plastic range, wherein, in the absence of other load, said portion is in tension after said axial compression constraint is released.
